(19) United States
(12) Patent Application Publication
(10) Pub. No.: US 2007/0236471 A1
(43) Pub. Date: Oct. 11, 2007

(54) Multi-media device

(76) Inventor: I-Hau Yeh, (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/401,258

(22) Filed: Apr. 11, 2006

(51) Int. Cl. G06F 3/041

(52) U.S. Cl. 345/173

(57) ABSTRACT

A multi-media device comprises a storage device to store multi-media files and a touchpad with a handwriting area thereon for user to input by handwriting to search or to name a file in the storage device. The storage device and the touchpad can be in a same device, or respectively in a separate master device and a control device. The multi-media device further comprises a display to show the input characters by handwriting on the touchpad.

### FIELD OF THE INVENTION

The present invention is generally related to a multi-media device and, more particularly, to a multi-media device with a touchpad.

### BACKGROUND OF THE INVENTION

The storage capacity and density of storage media such as hard disks, compact disks and semiconductor memories have continuously increased. With the improvement in coding technology, newer and better portable multi-media devices are developed. For example, MP3 player, which has become popular, is capable to store many songs for more practical entertainment effect. Besides, digital recorder extends the recording time from 2 to 3 hours as in a traditional recorder to hundreds of times of that with compact size and less power consumption. Future recording media could not only bring and play more songs portably, but also achieve the goal to play multi-media files on a portable device. However, conventional multi-media devices could only select songs or programs with certain buttons and sort the stored files with numbers, which makes it more inconvenient in using. For example, when a song is to be selected in a music player, it is hard to find the song if there are too many songs in the storage device. When a program is recorded on an analog or a digital recorder, user could not name the recorded program with any one or familiar one. It is also difficult to search a recorded program. Simply speaking, a conventional multi-media device is less user-friendly than a computer device, especially in file searching and naming. Apple Computer Corporation develops a portable digital music player named ipod. It uses a ring-shape touchpad as an interface for operations. When user slides clockwise on the touchpad, the music play list scrolls forwardly. Contrarily, when user slides counterclockwise, the music play list scrolls backwardly. Once the target song is found, it can be selected by pressing the button on the center of the panel. Though this operation makes it easier for user to search a song, the search is performed in a sequential way. All the songs are shown on the display one after another. If there are too many songs, the search becomes long and inconvenient. It also can't name the files in the device. A touchpad is a well-known and low-cost device, which was mainly used in notebook computers. Though Apple Computer Corporation uses it in a music player to simplify the operation, it is still inconvenient to operate such device. A further improvement is required.

### SUMMARY OF THE INVENTION

It is an object of the present invention to provide a multi-media device with a touchpad.

It is another object of the present invention to provide a multi-media device that is easy to search and to name a file.

It is yet another object of the present invention to provide a multi-media device with strengthened functions.

According to the present invention, a multi-media device comprises a storage device to store multi-media files and a touchpad with a handwriting area thereon for user to input by handwriting to search and to name a file in the storage device. In an embodiment, the storage device and the touchpad are in a same device. In other embodiments, the storage device and the touchpad are respectively on a separate master device and a control device, which are connected with a connection wire or a wireless communication interface. Preferably, the multi-media device further comprises a display to show the characters handwritten on the touchpad.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows an independent multi-media device according to the present invention;

FIG. 2 shows an embodiment of the touchpad according to the present invention;

FIG. 3 shows a multiple operation modes according to the present invention;

FIG. 4 shows a separate multi-media device according to the present invention;

FIG. 5 shows a second separate multi-media device according to the present invention;

FIG. 6 shows a third separate multi-media device according to the present invention;

FIG. 7 shows a fourth separate multi-media device according to the present invention;

FIG. 8 shows a fifth separate multi-media device according to the present invention;

FIG. 9 shows a sixth separate multi-media device according to the present invention;

FIG. 10 shows a seventh separate multi-media device according to the present invention; and

FIG. 11 shows an eighth separate multi-media device according to the present invention.

### DETAILED DESCRIPTION OF THE INVENTION

The embodiments below are used to express the features of the present invention. Some details of a typical multi-media device are thus eliminated. Those who are skilled in the related art of the present invention should understand the applications of the present invention in different circumstances.

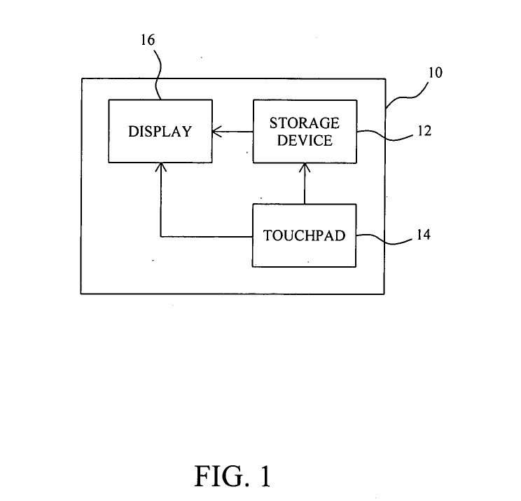

FIG. 1 shows an independent multi-media device according to the present invention. A multi-media device 10 comprises a storage device 12 and a touchpad 14 on the same device. The storage device 12 stores many multi-media files, and the touchpad 14 has a handwriting area for user to search or to name a file in the storage device 12 by handwriting. The multi-media device 10 further has a display 16. When user performs handwriting on the touchpad 14, the input characters are displayed on the display 16. More practically, user inputs keywords on the touchpad 14, such as a part of the file name, with the keywords shown on the display 16, and the storage device 12 is ordered to search. Files with names corresponding to the keywords are shown on the display 16 for user to perform a further search. Besides, after user selects a file therefrom, a new file name can be input on the touchpad 14 to rename the old one. These operation functions make it more convenient for user to operate the multi-media device 10 and at the same time, make the multi-media device 10 more powerful with functions such as building user's program list, naming a recorded program or a song.

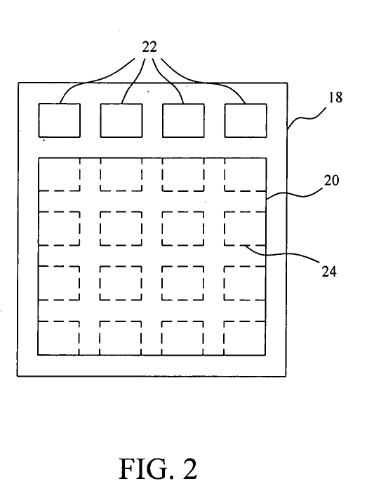

FIG. 2 shows an embodiment for the touchpad 14. There is a handwriting area 20 on the panel 18, with several button patterns 22 printed or attached on the panel 18. The patterns can be fluorescent for being recognized in dark. These button patterns 22 are used to simulate real buttons. Pressing the button patterns 22 will perform predetermined button functions, such as list, erase and input. The list button pattern is used to show a predetermined list or data; the erase button pattern is used to erase or to correct words, numbers, symbols or pictures written on the handwriting area 20. After user finishes the input of a single word or a phrase, the input button pattern is pressed to send the input to the multi-media device 10 to perform a file search or naming. In one embodiment, the button patterns 22 comprise one for mode switch. Pressing the mode switch pattern will switch the touchpad 14 to the handwriting mode or to another input mode. The handwriting area 20 is used for user to write under the handwriting mode, while other input modes perform corresponding input functions. For example, many button patterns 24 are printed in the handwriting area 20. When the touchpad 14 is switched to the button mode, the button patterns 24 are used to simulate real buttons, just as a keyboard. These button patterns 22 and 24 can also be used to provide additional functions, such as defining new function keys, integrating a hot key with multiple instructions or self-defining a fast key for a particular option. The mode switch button can also be a real button on the multi-media device 10.

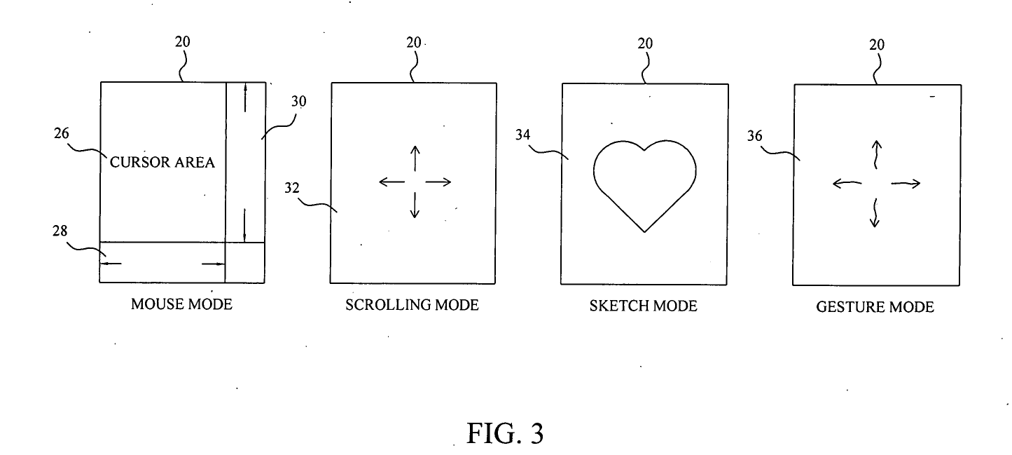

In different embodiments, the touchpad 14 can be defined to have input modes other than the handwriting input, such as mouse mode, scrolling mode, sketch mode and gesture mode. FIG. 3 shows a multiple operation modes of the touchpad 14. The switching between different operation modes is achieved by pressing the mode switch button pattern. When the touchpad 14 is switched to the mouse mode, the handwriting area 20 becomes a cursor area 26 and horizontal and vertical scrolling areas 28 and 30. User can control the cursor in the cursor area 26, while the horizontal and vertical scrolling areas 28 and 30 are used to simulate the horizontal and vertical scrolling functions of a mouse, which is similar to the horizontal and vertical scrolling bars in Microsoft Office Software. Under the scrolling mode, the whole handwriting area 20 becomes one scrolling area 32, and user can move his finger on the scrolling area 32 to scroll the list upward or downward, or to change list forward or backward. The difference between the scrolling area 32 under the scrolling mode and the scrolling areas 28 and 30 under the mouse mode is that the vertical and horizontal quantity of the movement in the scrolling area 32 are directly corresponding to the vertical and horizontal scrolling, or moving on a list, or moving between the lists. When the touchpad 14 is switched to the sketch mode, the handwriting area 20 becomes a picture input area 34 to input pictures. User can draw or edit a picture with his finger in the picture input area 34. There's an obvious difference between the sketch mode and the handwriting mode. Under the handwriting mode, when the input is stopped for a period of time, the handwriting input recognition module of the touchpad 14 automatically recognizes the traces input by user. While under the sketch mode, the completion of the picture input relies upon user's instruction. The above response time can be adjusted according to user's need. When the touchpad 14 is switched to the gesture mode, the upward gesture, downward gesture, leftward gesture and rightward gesture respectively represent four different operations. For example, the upward gesture and downward gesture respectively represent scrolling upward and downward. The leftward and rightward gestures can correspond to moving forward and backward in the multi-media device 10.

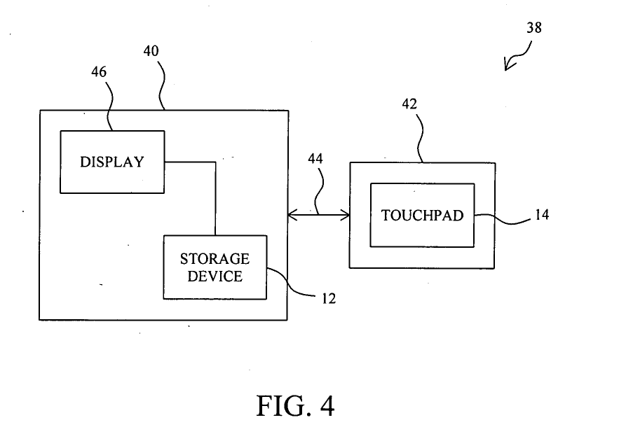

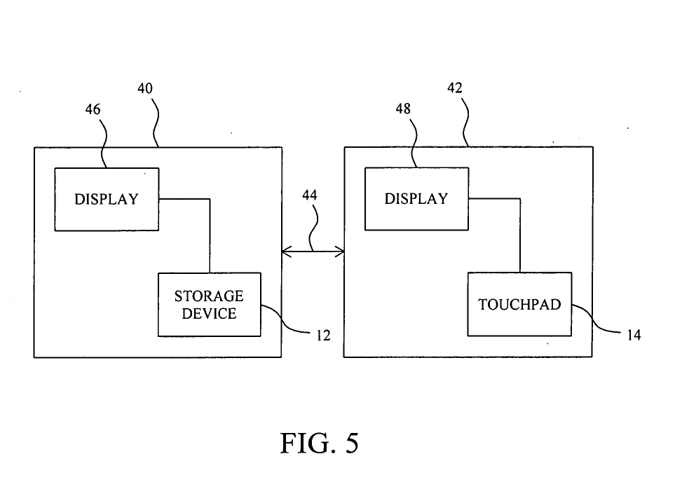

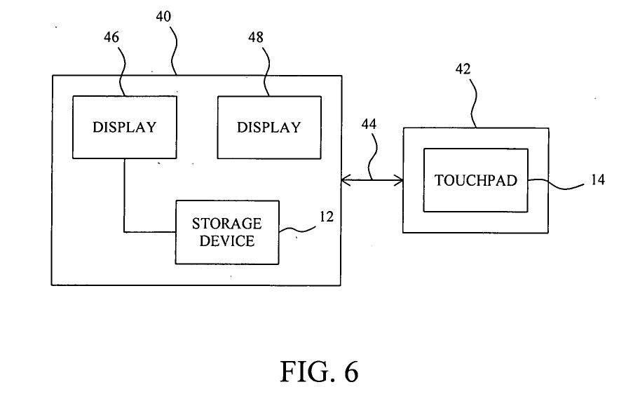

FIG. 4 shows a separate multi-media device according to the present invention. A multi-media device 38 comprises a master device 40 and a control device 42, which are connected with a connection wire 44. The master device 40 has a storage device 12 to store many multi-media files, and the control device 42 has a touchpad 14 with a handwriting area thereon for user to write to search or to name a file on the storage device 12. The master device 40 also has a display 46 to play the multi-media program and to show the input characters when the touchpad 14 is under operation. Practically, user inputs keywords on the touchpad 14 under the handwriting mode and the input is transferred to the master device 40 through the connection wire 44 to search the storage device 12. The operation to name a file is similar thereto. Alternatively, the control device 42 can also be equipped with a display 48 to show the input characters from the touchpad 14 as shown in FIG. 5, or the master device 40 has displays 46 and 48 to respectively play a multi-media program and to show the input characters from the touchpad 14 as shown in FIG. 6.

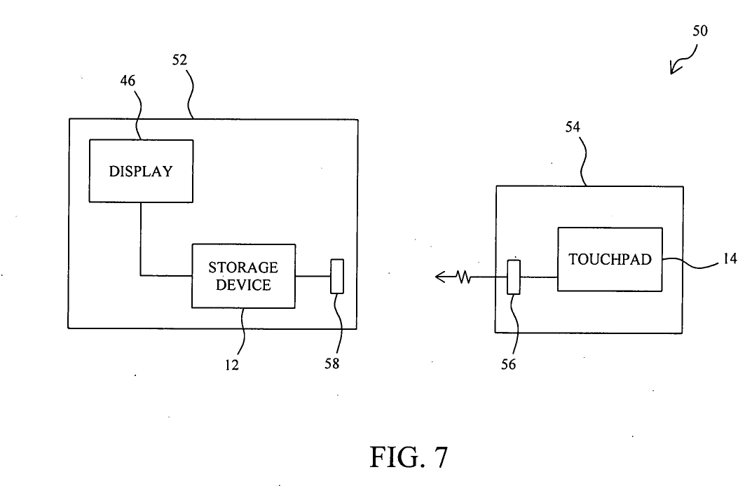

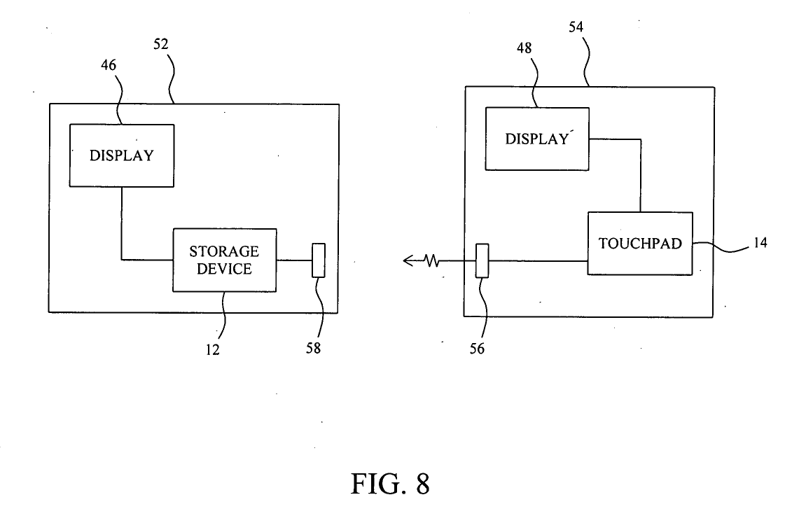

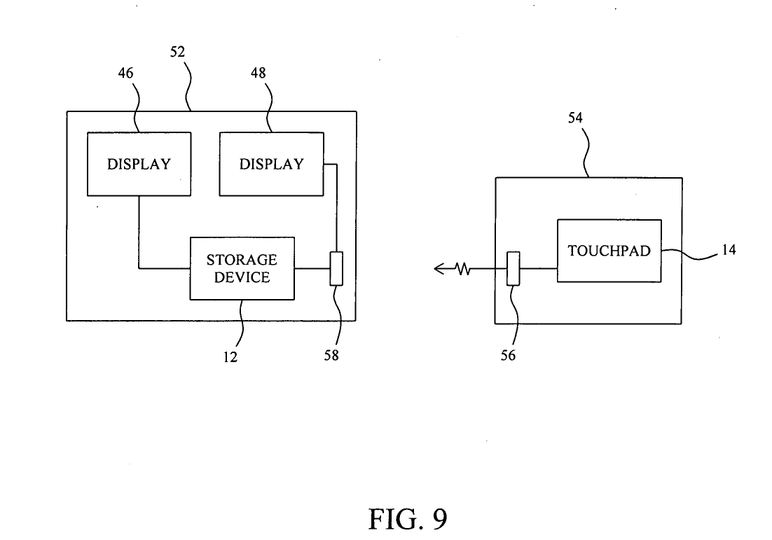

FIG. 7 shows yet another separate multi-media device according to the present invention. A multi-media device 50 comprises a master device 52 and a control device 54, which are connected by a wireless communication interface. The master device 52 has a storage device 12 to store many multi-media programs and a display 46 to play the programs, and the control device 54 has a touchpad 14 with a handwriting area thereon for user to write to search or to name a file in the storage device 12. The input characters written by user on the touchpad 14 are sent by a transmitter 56 in the control device 54 via wireless signal such as infrared or radio frequency to a receiver 58 in the master device 52, to be shown on the display 46 and to operate the storage device 12. Practically, keywords or new file names are inputted on the touchpad 14 under the handwriting mode, and are sent through the transmitter 56 in the control device 54 to the receiver 58 in master device 52 to search or to name a file in the storage device 12. Alternatively, the control device 54 can be equipped with a display 48 to show the input characters from the touchpad 14 as shown in FIG. 8, or the master device 52 comprises displays 46 and 48 to respectively play a multi-media program and to show the input characters from the touchpad 14 as shown in FIG. 9.

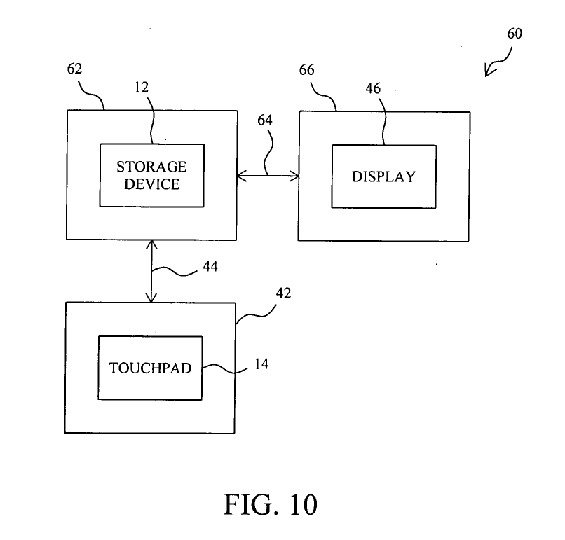

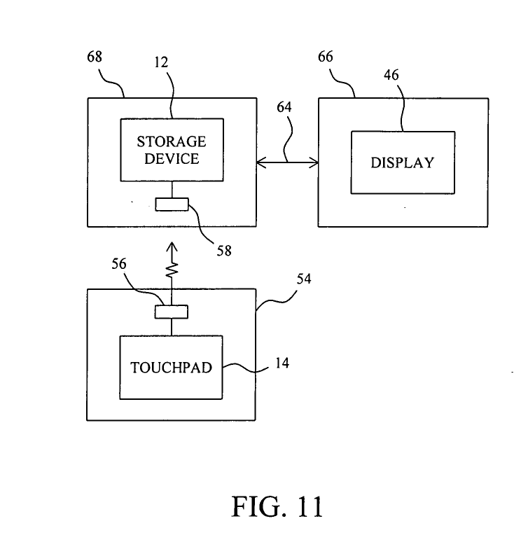

FIG. 10 shows yet another separate multi-media device according to the present invention. A multi-media device 60 comprises a master device 62 and a control device 42. The master device 62 has a storage device 12 and is connected with an output device 66 having a display 46 by a connection wire 64. The display 46 can play multi-media programs for the master device 62. The control device 42 has a touchpad 14 and is connected to the master device 62 by a connection wire 44. The touchpad 14 has a handwriting area for user to input and to search or to name a file in the storage device 12. When the touchpad 14 is under operation, the display 46 can be used to show the input characters from the touchpad 14. In another embodiment, as shown in FIG. 11, the master device 68 comprises a storage device 12 and a receiver 58 and is connected with an output device 66 that has a display 46. The display 46 can play multi-media programs for the master device 68. The control device 54 comprises a touchpad 14 and a transmitter 56. User inputs keywords or new file names on the touchpad 14 under the handwriting mode, and the input is transferred through the transmitter 56 in the control device 54 to the receiver 58 in the master device to search or to name a file in the storage device 12.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as string forth in the appended claims.

What is claimed is:

1. An independent multi-media device comprising:
a storage device for storing a plurality of multi-media files; and
a touchpad with a handwriting area thereon for user to input by handwriting to search on the storage device.

2. The multi-media device of claim 1, wherein the touchpad is capable of inputting by handwriting to name a file in the storage device.

3. The multi-media device of claim 1, wherein the touchpad comprises a mode switch pattern thereon for switching the touchpad between a handwriting mode and other input modes.

4. The multi-media device of claim 3, wherein the other input modes comprises a button mode, a mouse mode, a scrolling mode or a sketch mode.

5. The multi-media device of claim 1, further comprising a mode switch button for switching the touchpad between a handwriting mode and other input modes.

6. The multi-media device of claim 5, wherein the other input modes comprises a button mode, a mouse mode, a scrolling mode or a sketch mode.

7. The multi-media device of claim 1, further comprising a display to show the input characters from the touchpad by handwriting.

8. A separate multi-media device comprising:
a master device having a storage device for storing a plurality of multi-media files; and
a control device having a touchpad with a handwriting area thereon for user to input by handwriting to search on the storage device.

9. The multi-media device of claim 8, wherein the touchpad is capable of inputting by handwriting to name a file in the storage device.

10. The multi-media device of claim 8, wherein the touchpad comprises a mode switch pattern thereon for switching the touchpad between a handwriting mode and other input modes.

11. The multi-media device of claim 10, wherein the other input modes comprises a button mode, a mouse mode, a scrolling mode or a sketch mode.

12. The multi-media device of claim 8, further comprising a mode switch button for switching the touchpad between a handwriting mode and other input modes.

13. The multi-media device of claim 12, wherein the other input modes comprises a button mode, a mouse mode, a scrolling mode or a sketch mode.

14. The multi-media device of claim 8, further comprising a display on the control device to show the input characters from the touchpad by handwriting.

15. The multi-media device of claim 8, further comprising a display on the master device to show the input characters from the touchpad by handwriting.

16. The multi-media device of claim 8, further comprising a display connected to the master device to show the input characters from the touchpad by handwriting.

17. The multi-media device of claim 8, wherein the master device and the control device are connected with a connection wire.

18. The multi-media device of claim 8, wherein the master device and the control device are connected with a wireless communication interface.
